(19) United States
(12) Patent Application Publication
(10) Pub. No.: US 2013/0337184 A1
(43) Pub. Date: Dec. 19, 2013

(54) INTERMEDIATE TRANSFER MEMBERS

(71) Applicants: Meir Soria, Nes Ziona (IL); Yevgenia Rudoy, Nea Ziona (IL); Raia Silvniak, Nes Ziona (IL); Oshra Raviv, Nes Ziona (IL)

(72) Inventors: Meir Soria, Nes Ziona (IL); Yevgenia Rudoy, Nea Ziona (IL); Raia Silvniak, Nes Ziona (IL); Oshra Raviv, Nes Ziona (IL)

(73) Assignee: Hewlett-Packard Development Company, L.P., Fort Collins, CO (US)

(21) Appl. No.: 14/003,665

(22) PCT Filed: Mar. 7, 2011
(86) PCT No.: PCT/US11/27420

§ 371 Date: Sep. 6, 2013

(51) Int. Cl. C08F 2/46; G03G 15/01

(52) U.S. Cl. CPC G03G 15/1605
USPC 427/487; 399/302

(57) ABSTRACT

The present disclosure provides for an intermediate transfer member for receiving an ink image from a first surface and transferring it to a second surface, comprising: a base; a rubber layer disposed on the base; a primer disposed on the rubber layer and comprising an aminofunctional organic compound, a photoinitiator, and a catalyst; and a release layer disposed on the primer, wherein the release layer comprises a silicone polymer capable of being cured by the catalyst.

### BACKGROUND

Digital printing involves technologies in which a printed image is created directly from digital data, for example using electronic layout and/or desktop publishing programs. Methods of digital printing include full-color ink-jet printing, electrophotographic printing, laser printing, and thermal transfer printing.

Electrophotographic printing techniques involve the formation of a latent image on a photoconductor surface mounted on an imaging plate. The photoconductor is first sensitized to light, usually by charging with a corona discharge, and then exposed to light projected through a positive film of the document to be reproduced, resulting in dissipation of the charge in the areas exposed to light. The latent image is subsequently developed into a full image by the attraction of oppositely charged toner particles to the charge remaining on the unexposed areas. The developed image is transferred from the photoconductor to an intermediate transfer member, e.g., a rubber offset blanket, from which it is transferred to a substrate, such as paper, plastic or other suitable material, by heat or pressure or a combination of both to produce the printed final image.

The latent image is developed using either a dry toner (a colorant mixed with a powder carrier) or a liquid ink (a suspension of a colorant in a liquid carrier). The toner or ink generally adheres to the substrate surface with little penetration into the substrate. The quality of the final image is largely related to the size of the particles, with higher resolution provided by smaller particles.

Dry toners used in solid electrophotography are fine powders with a relatively narrow particle size distribution that are expelled from fine apertures in an application device. Liquid inks used in liquid electrophotography are generally comprised of pigment- or dye-based thermoplastic resin particles suspended in a non-conducting liquid carrier, generally a saturated hydrocarbon.

### BRIEF DESCRIPTION OF THE DRAWINGS

FIG. 1 is a cross-sectional view of an intermediate transfer member in accordance with examples of the present disclosure;

FIG. 2 is a flow chart of a method of producing an intermediate transfer member for digital offset printing in accordance with examples of the present disclosure; and

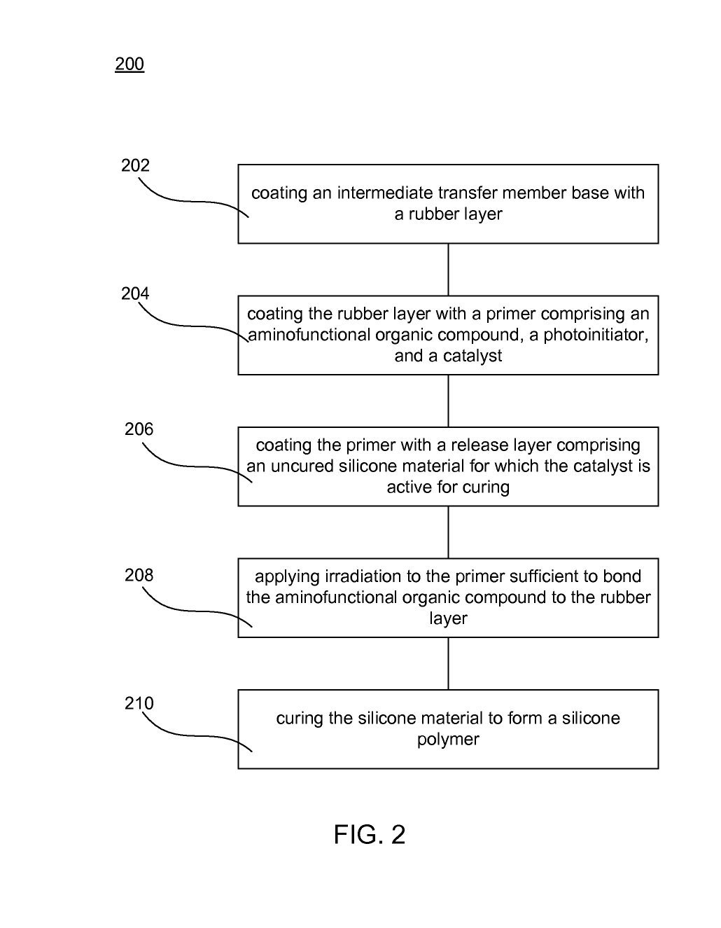

FIG. 3 is a flow chart of a method of adhering a silicone release layer to a rubber layer in accordance with examples of the present disclosure.

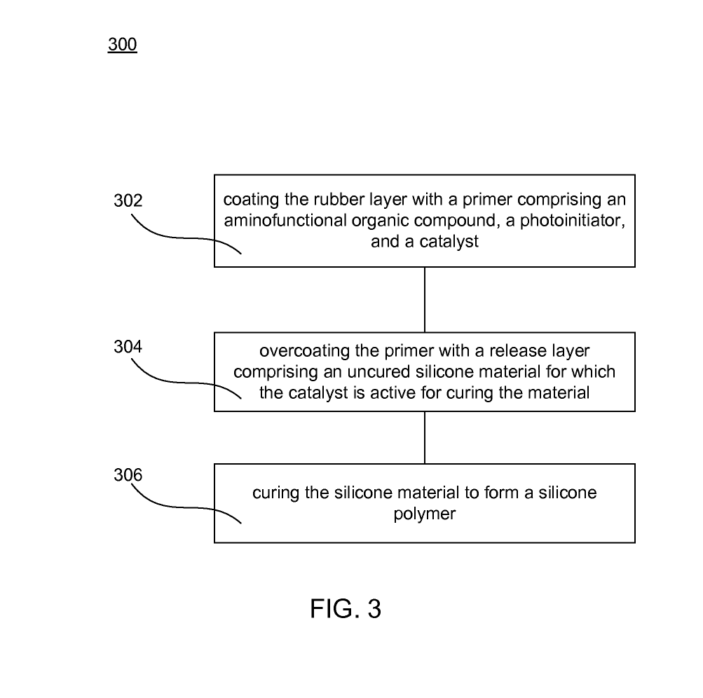

### DETAILED DESCRIPTION

Before the present invention is disclosed and described, it is to be understood that this disclosure is not limited to the particular process steps and materials disclosed herein because such process steps and materials may vary somewhat. It is also to be understood that the terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, “electrophotographic printing” generally refers to the process of printing by forming a latent image on a photoconductor surface mounted on an imaging plate, developing the latent image, transferring the developed image from the photoconductor to an intermediate transfer member, e.g., a rubber offset blanket, and transferring the developed image to a substrate. As noted herein, “digital offset printing” includes electrophotographic printing.

As used herein, “intermediate transfer member” or “ITM” is intended to include and encompass items that may also be referred to as “blankets” or “intermediate transfer media.”

As used herein, “rubber” refers to any natural or synthetic elastomer, e.g., acrylic rubber and nitrile rubber. In this regard, “substantially cured” refers to rubber that is more than 50% cured and “fully cured” refers to rubber that is more than 90% cured.

As used herein, “silicone polymer” refers to silicone materials that have been cured to form the silicone polymer. In this regard, “full cure” or “fully cured” refers to a silicone polymer that is more than 90% cured.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, the term “substantially” or “substantial” refers to the complete or nearly complete extent or degree of an action, characteristic, property, state, structure, item, or result. The exact allowable degree of deviation from absolute completeness may in some cases depend on the specific context. However, generally speaking, the nearness of completion will be so as to have the same overall result as if absolute and total completion were obtained. In this regard, “substantially cured” refers to rubber that is more than 50% cured.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

With these definitions in mind, generally, during the manufacturing of intermediate transfer members for electrophotographic printing, or digital offset printing, it has been difficult to assemble a silicone layer on a rubber layer because the release properties of silicone and rubber make it difficult to form chemical bonds to form at their respective surfaces. This is particularly true when the rubber layer is fully cured. However, it has been recognized that intermediate transfer members for electrophotographic printing can be manufactured with strong adhesion and significantly improved manufacturing time. Specifically, it has been discovered that the use of a primer comprising an aminofunctional organic compound, a photoinitiator, and a catalyst can provide strong adhesion of a silicone layer to a rubber layer on an intermediate transfer member with fast curing of the release layer.

In accordance with this, the intermediate transfer members of the present disclosure can provide excellent release characteristics for ink images during electrophotographic printing, extended durability of the intermediate transfer member, and fast manufacturability.

Thus, the present disclosure is drawn to intermediate transfer members and associated methods. That being understood, it is noted that when discussing the present intermediate transfer members and associated methods, each of these discussions can be considered applicable to each of these examples, whether or not they are explicitly discussed in the context of that example. For example, in discussing an aminofunctional organic compound for use in an intermediate transfer member, such an aminofunctional organic compound can also be used for a method of producing an intermediate transfer member for electrophotographic printing or a method of adhering a silicone release coating to a rubber member, and vice versa.

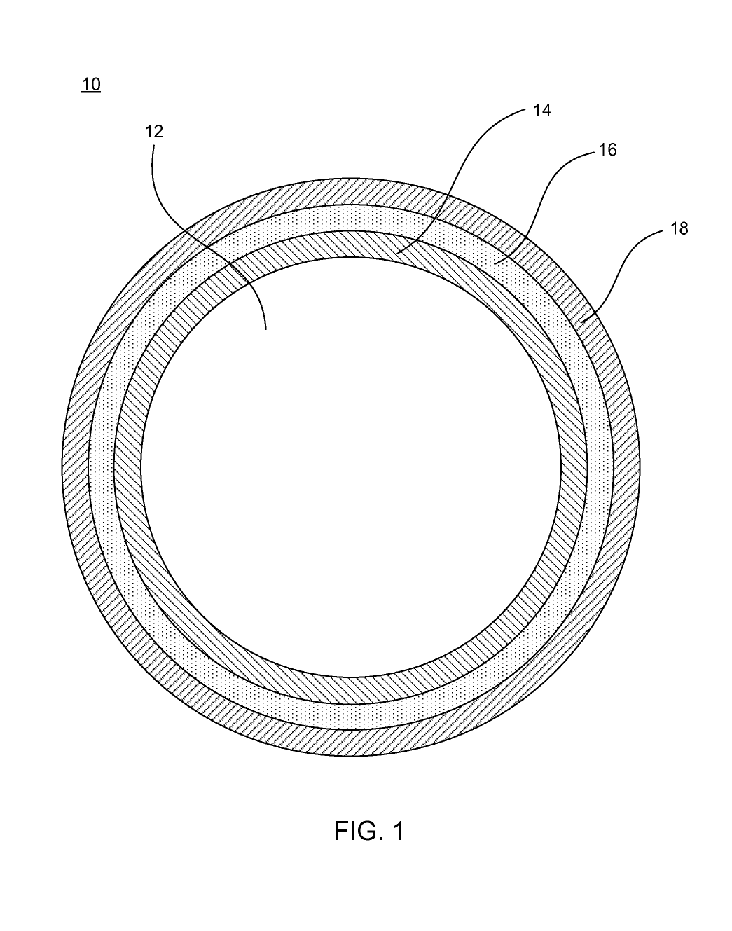

Turning now to FIG. 1, an intermediate transfer member 10 for receiving an ink image from a first surface and transferring it to a second surface can comprise a base 12; a rubber layer 14 disposed on the base; a primer 16 disposed on the rubber layer and comprising an aminofunctional organic compound, a photoinitiator, and a catalyst; and a release layer 18 disposed on the primer. In this example, the release layer comprises a silicone polymer capable of being cured by the catalyst.

Generally, the rubber layer 14 can comprise uncured rubber, substantially cured rubber, or fully cured rubber. The rubber layer can include, without limitation, acrylic rubbers, butadiene acrylonitrile rubbers, polyurethane rubbers, cured fluorosilicone elastomers, and mixtures thereof. In one example, the rubber layer can be a blend of an acrylic resin HyTemp® 4051 EP (from Zeon Chemicals) filled with black pigment, Black Pearls® 130 (from Cabot Corp.) and a curing system, which may comprise, for example, HyTemp® NPC-50 accelerator (quaternary ammonium compound in polyacrylate binder from Zeon) and sodium stearate crosslinker. The acrylic rubber can be substantially cured, and, in some examples, can be fully cured. Any suitable rubber can be used, including but not limited to nitrile rubber (NBR), hydrogenated nitrile rubber (HNBR), polyurethane elastomer (PU), fluorocarbon elastomer, and fluorosilicone.

The primer 16 can be applied to the outer surface of rubber layer 14. The primer can form a layer having a thickness of from about 0.01 micron to about 5 micron. Generally, the primer includes an aminofunctional organic compound, a photoinitiator, and a catalyst, though other ingredients can also be present. The aminofunctional organic compound can be selected from the group of an aminofunctional silane, an oligomer having amino functionality, or mixtures thereof. In one aspect, the aminofunctional organic compound can be an aminofunctional silane selected from the group of monoamine functional silane such as aminopropyltrimethoxysilane, aminopropyltriethoxysilane, etc.; from the group of diamine functional silane such as N-(2-aminoethyl)-3-aminopropyl trimethoxysilane, N-(2-aminoethyl)-3-aminopropyl triethoxysilane, etc.; from the group of triamine functional silane such as (3-trimethoxysilylpropyl)diethylene triamine, etc.; oligomers thereof; and the mixtures thereof. The amine group in the aminosilane can be a primary, secondary or tertiary amine functional group. Other functional amines such as dipodal amine functional silanes, e.g., bis(trimethoxysilylpropyl)amine, can be also used.

In one example, aminofunctional silanes can be, without limitation, 3-aminopropyltrimethoxysilane, such as Dynasylan® AMMO™ available from Degussa, AG of Piscataway, N.J. Other suitable aminofunctional organic compounds include, but are not limited to, 3-aminopropyltriethoxysilane (Dynasylan® AMEO™ from Degussa or SIA0610.0 from Gelest), N-(2-aminoethyl)-3-aminopropyl trimethoxysilane (Dynasylan® DAMO™ from Degussa or SIA0591.0 from Gelest), N-(2-aminoethyl)-3-aminopropyl triethoxysilane (SIA 0590.5 from Gelest). Generally, the aminofunctional organic compound can contain a hydrolysable portion for bonding to the silicone release layer. The hydrolyzable portion of the aminofunctional organic compound can be an alkoxy group (e.g., alkoxysilane with an alkoxy group selected from the group consisting of methoxy, ethoxy, propoxy, isopropoxy, methoxyethoxy, and the like). Generally, the aminofunctional organic compound can comprise about 5 to about 95 weight % of the total primer. In one aspect, the aminofunctional organic compound can comprise about 5 to about 45 weight % of the total primer. In another aspect, the aminofunctional organic compound can comprise about 30 to about 50 weight %.

Generally, the aminofunctional organic compound can be bonded to the rubber layer. Additionally, the aminofunctional organic compound can form a chemical barrier between the rubber layer and the release layer. Such a chemical barrier can prevent the leaching of chemicals between the rubber layer and the release layer. As such, increased durability can be provided as well as improved printing quality.

Additionally, other organosilane compounds can be used in the primer in conjunction with the aminofunctional organic compound. Such an organosilane compound can be, for example epoxyalkyl alkoxysilane (e.g., glycidoxypropyl trimethoxysilane-silane Dynasylan® GLYMO (Degussa)) alkenylsilane (e.g., vinyl or allyl alkoxysilane), alkylsilane, non-functional dipodal silane (e.g., bis triethoxysilyl octane), and their condensed forms constituted by oligomers of the monomers form of the silane. As noted above, such organosilanes can contain the hydrolyzable groups and the polar functional groups as listed for the aminofunctional organic compound. Additionally, the organosilane can comprise about 5 wt % to 90 wt % of the total primer, and in one aspect, can comprise about 5 wt % to 45 wt % of the total primer.

The photoinitiator can be any photoinitiator capable of bonding the aminofunctional organic compound with the rubber surface of the rubber layer. Generally, the photoinitiator can include, but is not limited to, α-hydroxyketones, α-aminoketones, benzaldimethyl-ketal, and mixtures thereof. In one example, the photoinitiator can comprise Darocur® 1173™, available from Ciba Specialty Chemicals of Newport, Del., which comprises 2-hydroxy 2-methyl 1-phenyl 1-propanone, CAS number 7473-98-5. Other suitable photoinitiators include, but are not limited to, Irgacure® 500™ (a 50/50 blend of 1-hydroxy-cyclohexyl phenyl ketone and benzophenone), Irgacure® 651™ (an α,α-dimethoxy α-phenyl acetophenone), Irgacure® 907™ (2-methyl-1-[4-(methylthio)phenyl]-2-(4-morpholinyl)-1-propanone) from Ciba Specialty Chemicals. Additionally, any other suitable photoinitiator may be used. Generally, the photoinitiator can comprise about 1 wt % to about 20 wt % of the total primer. In one aspect, the photoinitiator can comprise about 1 wt % to about 5 wt % of the total primer.

The catalyst component of primer can include, but is not limited to, tin compounds, organic titanates organic zirconates, and mixtures thereof. Additionally, the photoinitiator can comprise any suitable compound that is capable of catalyzing a condensation curing reaction of silicone. In one example, the catalyst can be acetylacetonate titanate chelate, available as Tyzor® AA-75 from E.I. du Pont de Nemours and Company of Wilmington, Del. In another example, the catalyst can comprise a tin compound, such as stannous octoate in xylene as a carrier. Generally, the catalyst can comprise about 1 wt % to about 30 wt % of the total primer. In one aspect, the catalyst can comprise about 1 wt % to about 10 wt % of the total primer.

The release layer 18 can comprise any silicone polymer. In one example, the silicone polymer can be a condensation type silicone. Generally, the silicone polymer can be polymerized from any curable silicone material capable of being cured by the catalyst. In one example, the silicone material can be an addition cure room temperature vulcanization (RTV) silicone material. In another example, the silicone material can be a condensation cure RTV silicone material. In addition to the above, in one example, the silicone polymer can be any silicone rubber. Generally, the release layer can have a thickness of about 1 μm to about 100 μm. In one aspect, the release layer can have a thickness of about 1 μm to about 15 μm thick. Further, as described in the examples, the silicone material can be capable of being fully cured within 30 minutes under ambient pressure and a temperature of 120° C.

Generally, the primer can be applied as a single layer containing all of the active components or can be applied as two or more layers. In one example, where a tin catalyst is used, a first layer containing the aminofunctional organic compound and the photoinitiator can be applied, and a separate, second layer containing the catalyst can be subsequently applied, so as to avoid negative interaction between the catalyst and the byproducts of photoinitiation.

Turning now to related methods, in one example, a method 200 of producing an intermediate transfer member for digital offset printing can comprise: coating an intermediate transfer member base with a rubber layer 202; coating the rubber layer with a primer comprising an aminofunctional organic compound, a photoinitiator, and a catalyst 204; coating the primer with a release layer comprising an uncured silicone material for which the catalyst is active for curing 206; applying irradiation to the primer sufficient to bond the aminofunctional organic compound to the rubber layer 208; and curing the silicone material to form a silicone polymer 210. In this example, the release layer is structurally bonded to the rubber layer.

Generally, the rubber layer can be fully cured or substantially cured prior to application of primer to the outer surface of rubber layer. However, each rubber has its own curing conditions and can depend on the selected curing system. As such, it is understood that the curing conditions for applying the rubber to the base can be modified as needed.

Generally, the curing of the silicon material can be at room temperature and under ambient pressure, although temperatures outside room temperature can be used as well as other pressures. Additionally, a full cure of the release layer (e.g. silicon material) can be performed within 30 minutes. In one aspect, a full cure of the release layer (e.g. silicon material) can be performed within 15 minutes. In another aspect, a full cure of the release layer (e.g. silicon material) can be performed within 5 minutes. Without intending to be bound by any particular theory, primers having aminofunctional organic compounds can provide faster curing times of the release layer to the rubber layer as compared to primers that use general organosilanes. Specific studies of the curing times for various primers are provided in the Examples.

If primer is to be applied as a single layer, a mixture containing the three components, namely aminofunctional organic compound, photoinitiator, and catalyst, can be applied to the outer surface of rubber layer, e.g., by wire rod or gravure coating. If the primer is to be applied in two or more steps, a first mixture, containing at least the photoinitiator and the aminofunctional organic compound, can be applied to the outer surface of rubber layer, e.g., by wire rod or gravure coating. Once the photoinitiator and the aminofunctional organic compound are present on the outside of rubber layer, the partially assembled ITM can be irradiated with optical energy having a wavelength that corresponds to the optimal wavelength for the photoinitiator. In one example, the radiation can be UV light. With the application of optical energy, the irradiation can cause the photoinitiator to form bonds with the rubber at the surface of the rubber layer and with the aminofunctional organic compound.

If the catalyst has not yet been applied, a mixture containing the catalyst can then be applied as a second layer to the outer surface of the first primer layer. Irradiation of the layer containing the photoinitiator can take place before placement of the catalyst. In the particular case of two layers of primer, the first layer that contains the photoinitiator and the aminofunctional organic compound can be applied, followed by irradiation. Afterwards, the second layer containing a catalyst (e.g., a condensation cure silicone catalyst such as a tin compound) can be applied before the coating of the release (silicone layer). The silicone material can then be applied to the outer surface of the layer containing the catalyst, so as to form release layer 18. The silicone material can be cured by subjecting it to heat and/or humidity, with the catalyst increasing the rate of cure. In an alternative embodiment, UV radiation can be applied at the end of the coating processes, after the condensation cure silicone release layer has been applied to the rubber layer, instead of applying UV radiation to the primer.

The assembled ITM, comprising base 12, rubber layer 14, and release layer 18, with a primer layer 16 forming a structural bond between rubber layer and release layer, can be used in a conventional digital offset printing process such as electrophotographic printing.

Turning to another example, a method 300 of adhering a silicone release layer to a rubber layer can comprise: coating a rubber layer with a primer comprising an aminofunctional organic compound, a photoinitiator, and a catalyst 302; overcoating the primer with a release layer comprising an uncured silicone material for which the catalyst is active for curing the material 304; and curing the silicone material to form a silicone polymer 306. Again, in this example, the silicone release layer is structurally bonded to the rubber layer.

As discussed herein, the method can further include the step of irradiating the primer so as to cause the aminofunctional organic compound to bond to the rubber layer before carrying out the step of overcoating the primer with the release layer. Additionally, the method can further comprise, after carrying out the step of overcoating the primer with the release layer, irradiating the primer so as to cause the aminofunctional organic compound to bond to the rubber layer.

### EXAMPLES

The following examples illustrate a number of variations of the present devices and methods that are presently known. However, it is to be understood that the following are only exemplary or illustrative of the application of the principles of the present compositions and methods. Numerous modifications and alternative compositions and methods may be devised by those skilled in the art without departing from the spirit and scope of the present compositions and methods. The appended claims are intended to cover such modifications and arrangements. Thus, while the present devices and methods have been described above with particularity, the following examples provide further detail in connection with what are presently deemed to be acceptable.

### Example 1

### Comparative Intermediate Transfer Member w/ Primer Composition (MEMO)

A comparative primer composition comprising Dynasylan® MEMOT™, GLYMO™, Darocur® 1173, and Tyzor® AA75 were applied to a cured acrylic rubber substrate in the amount listed in Table 1.

A release coating (silicone condensation cure type) was applied on the primer layer. The primer and release coating layers were then UV irradiated by 300 W/in Fusion H ultraviolet lamp at a line speed of 5 meters per minute without the need of nitrogen.

The release coating is further cured at 120° C. for 1 hour to provide a fully cured silicone release layer.

TABLE 1

| Components | Wt % |
|---|---|
| Dynasylan ® MEMO ™ | 42.5 |
| Dynasylan ® GLYMO ™ | 42.5 |
| Darocur ® 1173 | 5 |
| Tyzor ® AA75 | 10 |

The intermediate transfer member was the characterized, and the results are listed in Table 2. The gloss was measured using a glossmeter that gives the amount of reflected light after illumination. The wet abrasion test was performed by soaking the blanket in Isopar® L (a high-purity isoparaffinic solvent by Exxon Mobile Corp) for 1 min at room temperature and then abraded with a cloth. The results are scaled as follows: 1=bad, release layer easily removed; 2=fair, release layer removed with small effort; 3=good, release layer removed only with great effort; 4=excellent, release layer cannot be manually removed. The tackiness was measured as the distance that a small metallic ball was rolled over the release layer surface.

TABLE 2

| Characteristic | Amount |
|---|---|
| Time for Full Cure | 60 minutes |
| Initial Gloss | 88.3 |
| Wet Gloss w/ Isopar ® L | 70.3 |
| Wet Abrasion | 4 |
| Tackiness (rolling ball in cm) | >50 |

### Example 2

### Intermediate Transfer Member w/ Primer Composition (AMMO aminopropyltrimethoxysilane)

A primer composition comprising Dynasylan® GLYMO™, Dynasylan® AMMO™, Darocur® 1173, and Tyzor® AA75 were applied to a cured acrylic rubber substrate in the amount listed in Table 3. The same release coating as used in Example 1 (silicone condensation cure type) was applied on the primer layer.

The primer and release coating layers are then UV irradiated by 300 W/in Fusion H ultraviolet lamp at a line speed of 5 meters per minute without the need of nitrogen.

The release coating is finally cured at 120° C. for 10 minutes to provide a fully cured silicone release layer.

TABLE 3

| Components | Wt % |
|---|---|
| Dynasylan ® AMMO ™ | 40 |
| Dynasylan ® GLYMO ™ | 45 |
| Darocur ® 1173 | 5 |
| Tyzor ® AA75 | 10 |

The intermediate transfer member was then characterized in the same manner as Example 1, with the results listed in Table 4 below.

TABLE 4

| Characteristic | Amount |
|---|---|
| Time for Full Cure | 10 minutes |
| Initial Gloss | 87.3 |
| Wet Gloss w/ Isopar ® L | 72 |
| Wet Abrasion | 4 |
| Tackiness (rolling ball in cm) | >50 |

As shown in Table 2, the intermediate transfer member provided comparable gloss, abrasion, and tackiness while provided a full cure in significantly less time than the comparative intermediate transfer member of Example 1.

### Example 3

### Intermediate Transfer Member w/ Primer Composition (AMEO aminopropyltriethoxysilane)

A primer composition comprising Dynasylan® GLYMO™, Dynasylan® AMEO™, Darocur® 1173, and Tyzor® AA75 were applied to a cured acrylic rubber substrate in the amount listed in Table 5.

The same release coating as used in Example 1 (silicone condensation cure type) was applied on the primer layer.

The primer and release coating layers are then UV irradiated by 300 W/in Fusion H ultraviolet lamp at a line speed of 5 meters per minute without the need of nitrogen.

The release coating is finally cured at 120° C. for 5 minutes to provide a fully cured silicone release layer.

TABLE 5

| Components | Wt % |
|---|---|
| Dynasylan ® AMEO ™ | 40 |
| Dynasylan ® GLYMO ™ | 45 |
| Darocur ® 1173 | 5 |
| Tyzor ® AA75 | 10 |

Similar to the AMMO intermediate transfer member of Example 2, the present AMEO intermediate transfer member provided a significantly faster cure time.

### Example 4

### Intermediate Transfer Member w/ Primer Composition (N-(2-Aminoethyl)-3-aminopropyl triethoxysilane SIA0590.5)

A primer composition comprising Dynasylan® GLYMO™, SIA0590.5, Darocur® 1173, and Tyzor® AA75 were applied to a cured acrylic rubber substrate in the amount listed in Table 6.

The same release coating as used in Example 1 (silicone condensation cure type) was applied on the primer layer.

The primer and release coating layers are then UV irradiated by 300 W/in Fusion H ultraviolet lamp at a line speed of 5 meters per minute without the need of nitrogen.

The release coating is finally cured at 120° C. for 15 minutes to provide a fully cured silicone release layer.

TABLE 6

| Components | Wt % |
|---|---|
| Gelest SIA0590.5 | 42.5 |
| Dynasylan ® GLYMO ™ | 42.5 |
| Darocur ® 1173 | 5 |
| Tyzor ® AA75 | 10 |

Similar to the AMMO and AMEO intermediate transfer member, the present SIA0590.5 intermediate transfer member provided a faster cure time.

### Example 5

### Pot Life Data

The pot life of the primers for the intermediate transfer members of Examples 1, 2, 3 and 4 were measured. Pot life refers to the available working time (processability time) of the primers when applied to the intermediate transfer layer before curing. The results are listed in Table 7.

TABLE 7

| | Example 1 | Example 2 | Example 3 | Example 4 |
|---|---|---|---|---|
| Pot life | 90-120 | 10-15 | 60-70 | 30 |
| (minutes) | | | | |

Notably, the Dynasylan AMEO of Example 3 provided a good compromise with the shortest curing time associated with acceptable pot life. As such, in one example and without being limiting, the intermediate transfer member can comprise a primer having a good pot life of at least 60 minutes with a cure time within 15 minutes, as set forth in with Example 3.

### Example 6

### Dilution of AMEO Primer

The primer (AMEO formulation from Example 3) was diluted with isopropyl alcohol (IPA) as provided in Table 8

TABLE 8

| | #1 | #2 | #3 |
|---|---|---|---|
| Primer | (Wt %) | (Wt %) | (Wt %) |
| AMEO ™ Primer | 100 | 100 | 100 |
| (example3) | | | |
| IPA | — | 20 | 30 |

The primers were applied as in Example 3 and characterized as shown in Table 9.

TABLE 9

| Primer | #1 | #2 | #3 |
|---|---|---|---|
| Curing time at 120° C. | 5 | 5-10 | 10 |
| (minutes) | | | |
| Wet Abrasion | 4 | 4 | 4 |

Notably, the Dynasylan AMEO primer can be used with IPA dilution until about 20% without degrading the benefit in curing performance. Additionally, even with a dilution of 30% with IPA, the primer still cured within 15 minutes.

### Example 7

### Level of Aminosilane in Primer

Several levels of aminosilane (AMEO) were tested in primer formulation as shown in Table 10.

TABLE 10

| Primer | #1 | #2 | #3 |
|---|---|---|---|
| Dynasylan ® AMEO ™ | 20 | 30 | 40 |
| Dynasylan ® GLYMO ™ | 65 | 55 | 45 |
| Darocur ® 1173 | 5 | 5 | 5 |
| Tyzor ® AA75 | 10 | 10 | 10 |

The primer was applied as in Example 3 and characterized as shown in Table 11.

TABLE 11

| Primer | #1 | #2 | #3 |
|---|---|---|---|
| Curing time at 120° C. | >10 | 10 | 5 |
| (minutes) | | | |
| Wet Abrasion | 3 | 4 | 4 |

The reduction of curing time was achieved with an AMEO concentration of about 30% or more in the primer. In one example, the aminofunctional organic compound can be present in the primer at a concentration of about 40% to about 95%.

While the disclosure has been described with reference to certain examples, those skilled in the art will appreciate that various modifications, changes, omissions, and substitutions can be made without departing from the spirit of the disclosure. It is intended, therefore, that the invention be limited only by the scope of the following claims.

What is claimed is:

1. An intermediate transfer member, comprising:
a base;
a rubber layer disposed on the base;
a primer disposed on the rubber layer and comprising an aminofunctional organic compound, a photoinitiator, and a catalyst; and
a release layer disposed on the primer, wherein the release layer comprises a curable silicone material that is reactive with the catalyst to form a silicone polymer.

2. The intermediate transfer member of claim 1, wherein the aminofunctional organic compound is selected from the group of an aminofunctional silane, an oligomer having amino functionality, or mixtures thereof.

3. The intermediate transfer member of claim 1, wherein the aminofunctional organic compound is an aminofunctional silane selected from the group of aminopropyltrimethoxysilane, aminopropyltriethoxysilane, N-(2-aminoethyl)-3-aminopropyl trimethoxysilane, N-(2-aminoethyl)-3-aminopropyl triethoxysilane, oligomers thereof, and/or mixtures thereof.

4. The intermediate transfer member of claim 1, wherein the aminofunctional organic compound is bonded to the rubber layer and forms a chemical barrier between the rubber layer and the release layer.

5. The intermediate transfer member of claim 1, wherein the silicone polymer is a condensation type silicone polymer.

6. The intermediate transfer member of claim 1, wherein the rubber layer comprises substantially cured rubber or fully cured rubber.

7. The intermediate transfer member of claim 1, wherein the silicone material is capable of being fully cured within 30 minutes under ambient pressure and a temperature of 120° C.

8. The intermediate transfer member of claim 1, wherein the silicone material is cured by the catalyst to form of the silicone polymer.

9. The intermediate transfer member of claim 1, wherein the rubber is selected from the group of acrylic rubbers, butadiene acrylonitrile rubbers, polyurethane rubbers, cured fluorosilicone elastomers, and mixtures thereof; the catalyst is selected from the group of tin compounds, organic titanates organic zirconates, and mixtures thereof; and the photoinitiator is selected from the group of α-hydroxyketones, α-aminoketones, benzaldimethyl-ketal, and mixtures thereof.

10. A method of producing an intermediate transfer member for digital offset printing, comprising:
coating an intermediate transfer member base with a rubber layer;
coating the rubber layer with a primer comprising an aminofunctional organic compound, a photoinitiator, and a catalyst;
coating the primer with a release layer comprising an uncured silicone material for which the catalyst is active for curing;
applying irradiation to the primer sufficient to bond the aminofunctional organic compound to the rubber layer; and
curing the silicone material to form a silicone polymer,
wherein the release layer is structurally bonded to the rubber layer.

11. The method of claim 10, wherein the step of coating the rubber layer with the primer is carried out in three steps, comprising:
applying the aminofunctional organic compound and the photoinitiator to the rubber layer;
applying the irradiation to bond the aminofunctional organic compound to the rubber layer; and
applying the catalyst to the aminofunctional organic compound.

12. The method of claim 10, wherein the step of applying the irradiation to the primer is performed before step of coating the primer with the release layer.

13. The method of claim 10, wherein the step of curing the silicone material to form a silicone polymer provides a full cure within 30 minutes.

14. A method of adhering a silicone release layer to a rubber layer, comprising:
coating the rubber layer with a primer comprising an aminofunctional organic compound, a photoinitiator, and a catalyst;
overcoating the primer with a release layer comprising an uncured silicone material for which the catalyst is active for curing the material; and
curing the silicone material to form a silicone polymer,
wherein the silicone release layer is structurally bonded to the rubber layer.

15. The method of claim 14, further including the step of irradiating the primer so as to cause the aminofunctional organic compound to bond to the rubber layer before carrying out the step of overcoating the primer with the release layer or including the step of, after carrying out the step of overcoating the primer with the release layer, irradiating the primer so as to cause the aminofunctional organic compound to bond to the rubber layer.
